(19) United States
(12) Patent Application Publication
(10) Pub. No.: US 2008/0035574 A1
(43) Pub. Date: Feb. 14, 2008

(54) Membrane Barrier films and method of use

(76) Inventors: Craig Y. Sabottke, Annandale, NJ (US); Bal K. Kaul, Fairfax, VA (US); Dennis G. Peiffer, Annandale, NJ (US)

Correspondence Address: ExxonMobil Research and Engineering Company, P.O. Box 900, Annandale, NJ, 08801-0900, US

(21) Appl. No.: 11/890,228

(22) Filed: Aug. 3, 2007

Related U.S. Application Data
(60) Provisional application No. 60/836,326, filed on Aug. 8, 2006.

(51) Int. Cl. B01D 61/14; B01D 69/10; B01D 71/00

(52) U.S. Cl. 210/651; 210/321.6

(57) ABSTRACT

This invention relates to a polymeric membrane assembly which incorporates one or more layers of protective barrier films or protective barrier membrane layers to protect the susceptible polymer membrane from deterioration due to contact with water, oxygen or a combination of both. This invention also relates to a process for utilizing these polymeric membrane assemblies in separation processes involving hydrocarbon feedstreams. More particularly, but not by way of limitation, this invention relates to the use of these polymeric membrane assemblies in processes involving the separation of aromatics from a hydrocarbon based feedstream.

### CROSS-REFERENCE TO RELATED APPLICATIONS

This application is a United States utility application which claims priority to U.S. Provisional Patent Application Ser. No. 60/836,326, filed Aug. 8, 2006.

### FIELD OF THE INVENTION

This invention relates to a polymeric membrane assembly which incorporates one or more layers of protective barrier films or protective barrier membrane layers to protect the susceptible polymer membrane from deterioration due to contact with water, oxygen or a combination of both. This invention also relates to a process for utilizing these polymeric membrane assemblies in separation processes involving hydrocarbon feedstreams. More particularly, but not by way of limitation, this invention relates to the use of these polymeric membrane assemblies in processes involving the separation of aromatics from a hydrocarbon based feedstream.

### BACKGROUND OF THE INVENTION

Polymeric membrane based separation processes such as reverse osmosis, pervaporation and perstraction are conventional. In the pervaporation process, a desired feed component, e.g., an aromatic component, of a mixed liquid feed is preferentially absorbed by the membrane. The membrane is exposed at one side to a stream comprised of a mixture of liquid feeds and a vacuum is applied to the membrane at the opposite side so that the adsorbed component migrates through the membrane and is removed as a vapor from the opposite side of the membrane via a solution-diffusion mechanism. A concentration gradient driving force is therefore established to selectively pass the desired components through the membrane from its upstream side to its downstream side.

The perstraction process is utilized to separate a liquid stream into separate products. In this process, the driving mechanism for the separation of the stream into separate products is provided by a pressure or concentration differential exerted across the membrane. Certain components of the fluid will preferentially migrate across the membrane because of the physical and compositional properties of both the membrane and the process fluid, and will be collected on the other side of the membrane as a permeate. Other components of the process fluid will not preferentially migrate across the membrane and will be swept away from the membrane area as a retentate stream. Due to the pressure mechanism of the perstraction separation, it is not necessary that the permeate be extracted in the vapor phase. Therefore, no vacuum is required on the downstream (permeate) side of the membrane and the permeate emerges from the downstream side of the membrane in the liquid phase.

A myriad of polymeric membrane compositions have been developed over the years. Such compositions include polyurea/urethane membranes (U.S. Pat. No. 4,914,064), polyurethane imide membranes (U.S. Pat. No. 4,929,358), polyester imide copolymer membranes (U.S. Pat. No. 4,946,594), and diepoxyoctane crosslinked/esterfied polyimide/polyadipate copolymer (diepoxyoctane PEI) membranes (U.S. Pat. No. 5,550,199). Additional membranes developed from the polycarbonate membrane family include polyphthalate carbonate membranes (U.S. Pat. No. 5,012,035), non-porous polycarbonate membranes (U.S. Pat. No. 5,109,666), and polyarylate membranes (U.S. Pat. No. 5,012,036).

Major factors affecting the design performance (i.e., the selectivity and flux rate) of a polymeric membrane include the composition of the membrane material, the concentration of the membrane material in solution, the curing or chemical reaction methods, and the final thickness of the cast membrane. However, it has been discovered that contaminants in a hydrocarbon feedstream can also have significant detrimental effects on the performance of these polymer based membranes. Some of these detrimental effects can be limited to the timeframe in which the membrane is exposed to these contaminants, wherein the membrane performance is diminished only while the contaminants are present in the feedstream and the membrane performance is returned to or near the performance level of the membrane prior to the exposure to the contaminants once the contaminants are removed from the feedstream. However, it is often the case that at certain levels, these contaminants can permanently damage the membrane, resulting in permanent performance degradation of the membrane even after the contaminants are removed from the feedstream.

Contaminants, in particular two common contaminants, water and oxygen, can have a significant detrimental effect on polymer membranes. U.S. Pat. No. 5,095,171, to Feimer et al., which is herein incorporated by reference, shows the deleterious effects oxygen can have upon a polymer membrane.

It is also known that water contained in a feedstream can have detrimental effect on the integrity and performance certain polymeric membranes. Details of a test showing the adverse impacts of even low amounts of water concentration in a hydrocarbon feedstream in contact with a PEI membrane is contained herein. In many cases, the corresponding damage to the membrane and decline of the membrane performance is both permanent and irreversible.

Therefore, there exists in the industry a need to provide a system of protection against harmful contaminants for polymer membrane systems without the need to remove the harmful contaminants from a feedstream or the need to inject blocking agents, scavenging agents or other chemicals into a feedstream prior to contact with a polymeric membrane.

### SUMMARY OF THE INVENTION

The present invention relates to a membrane assembly for separating aromatics from a hydrocarbon feedstream containing aromatics and non-aromatics wherein at least one polymer membrane element or polymer membrane layer which is susceptible to physical damage or performance impacts due to either water or oxygen in the hydrocarbon feedstream is protected by the use of a water (hydrophobic) or oxygen (vapor) barrier film or barrier membrane layer.

In one embodiment, the present invention includes a membrane assembly for separating aromatics from a hydrocarbon feedstream containing aromatics and non-aromatics comprised of:
a) at least one polymer membrane element, and
b) a hydrophobic barrier film;
   wherein the polymer element and the hydrophobic barrier film are enclosed in a is housing; the hydrophobic barrier film is oriented in the housing on the feedstream side of the polymer membrane element; and the hydrophobic barrier film is substantially impermeable to water.

Similarly, another embodiment is a membrane assembly for separating aromatics from a hydrocarbon feedstream containing aromatics and non-aromatics comprised of:
a) at least one polymer membrane element, and
b) a vapor barrier film;
   wherein the polymer element and the vapor barrier film are enclosed in a housing; the vapor barrier film is oriented in the housing on the feedstream side of the polymer membrane element; and the vapor barrier film is substantially impermeable to oxygen.

In another embodiment, the hydrophobic barrier film or the vapor barrier film is comprised of a compound selected from polytetrafluoroethylene, polyvinylfluoride, polyvinylidenefluoride, polypropylene, polyethylene, polycarbonate, polysulfone, and silicone.

In yet another preferred embodiment, a single film with both hydrophobic and vapor barrier characteristics is utilized in the membrane assembly.

In still yet another preferred embodiment, the membrane assembly of the present invention is comprised of a housing containing at least one polymer membrane element, wherein the polymer element is comprised of at least one active polymer membrane layer and at least one hydrophobic barrier membrane layer; the active polymer membrane layer and the hydrophobic barrier membrane layer are chemically-crosslinked to form an integrally-layered membrane element; the hydrophobic barrier membrane layer is oriented in the housing on the feedstream side of the active polymer membrane layer; and the hydrophobic barrier membrane layer is substantially impermeable to water.

In another preferred embodiment, the membrane assemblies of the present invention are utilized in a process for separating aromatics from a hydrocarbon feedstream containing aromatics and non-aromatics. In a more preferred embodiment, the hydrocarbon feedstream is a naphtha with a boiling range of about 80 to about 450° F. (27 to 232° C.), and the aromatic enriched permeate stream is utilized as a motor gasoline blending component.

### BRIEF DESCRIPTION OF THE DRAWINGS

FIG. 1 shows a graph illustrating the detrimental effects of water in the feedstream on the flux rates of a polyimide-polyadipate copolymer (PEI) membrane system.

FIG. 2 illustrates one embodiment of the present invention wherein a hydrophobic barrier film, a vapor barrier film, or a combination film is utilized in an assembly in conjunction with a copolymer membrane composition cast upon a suitable support material.

FIG. 3 illustrates one embodiment of the present invention wherein both a hydrophobic barrier film and a vapor barrier film is utilized in an assembly in conjunction with a copolymer membrane composition cast upon a suitable support material.

FIG. 4 illustrates one embodiment of the present invention wherein a hydrophobic barrier membrane layer and/or a vapor barrier membrane layer is chemically cross-linked with an active polymeric membrane layer cast upon a suitable support material to form an integrally-layered membrane element.

### DETAILED DESCRIPTION OF THE PREFERRED EMBODIMENTS

The present invention solves the previously mentioned problem by utilizing a membrane assembly comprised of a barrier film system designed to protect a polymer membrane from damage from a hydrocarbon feed containing water as a contaminant, oxygen as a contaminant, or a combination of both water and oxygen. As discussed, water and oxygen can have a significant detrimental effect on polymer membranes.

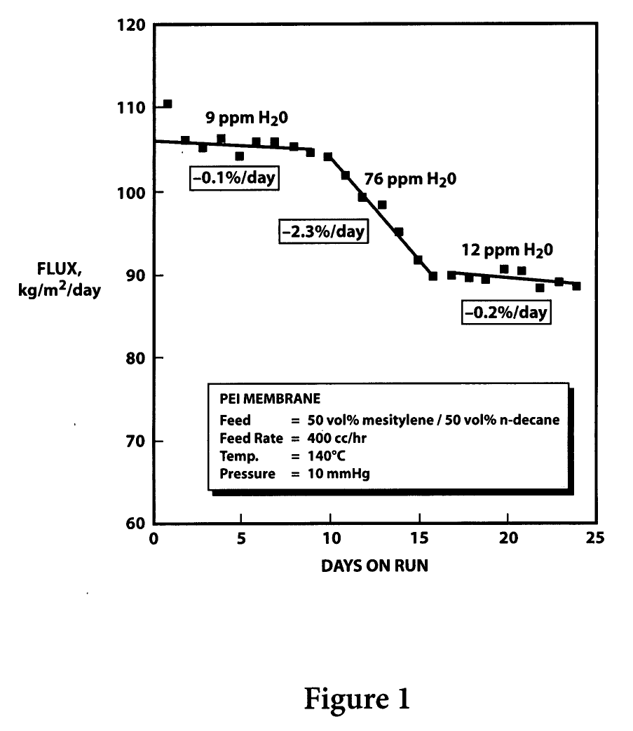

A test was conducted to determine the effect of water on a polyimide-polyadipate copolymer (PEI) membrane in an application for aromatics separation from a hydrocarbon feedstream. The composition of this membrane is detailed in U.S. Pat. No. 4,990,275, which is herein incorporated by reference. The test utilized a 50 vol. % mesitylene/50 vol. % n-decane solution as the feedstream. As FIG. 1 illustrates, the membrane was initially subjected to a feed with 9 ppm water which resulted in a very mild flux reduction over time. However, when the water content was increased to 75 ppm, a very dramatic decrease in both the flux and the flux reduction rate was experienced. When the water content was again decreased to 12 ppm, the flux reduction rate again stabilized, but as can be seen in FIG. 1, the actual flux of the membrane was therefore unexpectedly permanently reduced after the exposure to the process with 75 ppm water content. The membrane was therefore permanently damaged by the exposure to the higher water content.

The permeate from the above experiment was tested by field desorption mass spectrometry (FDMS) which identified polymer fragments with molecular weights ranging from 350 to 600 in the permeate product. It is believed that the water slowly hydrolyzes the membrane causing a flux reduction. This permeate analysis data showing the actual loss of membrane material is consistent with the performance data showing that the polymer membrane is permanently damaged after contact with water and that the polymer membrane does not return to its prior performance levels once the water is removed from the process.

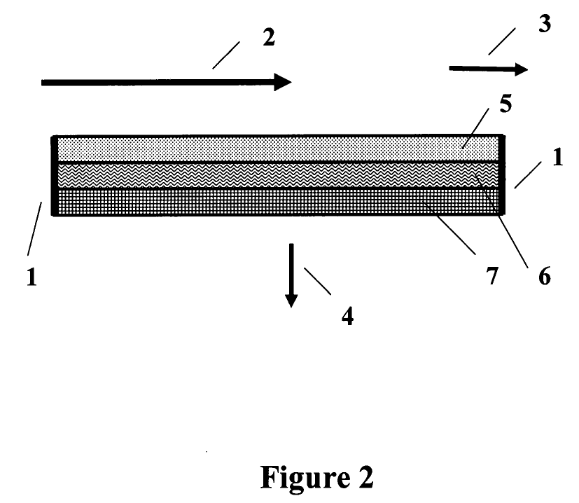

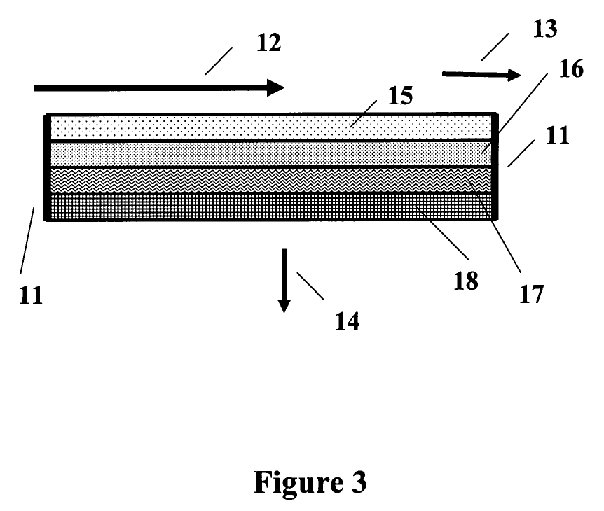

Another contaminant known to be detrimental to polymer membranes is oxygen. U.S. Pat. No. 5,095,171, to Feimer et al., which is herein incorporated by reference, shows the deleterious effects of oxygen upon a polymer membrane. Examples 3 and 4 and respective corresponding FIGS. 2 and 3 of the Feimer patent show that the exposure of the membranes to oxygen levels in the feed of >50 ppm result in a dramatic decrease in the membrane flux. In Example 3 and corresponding FIG. 2 of the Feimer patent, it can be seen that even after removal of oxygen from the feed and subsequent purging of the membrane, exposure to the oxygen had resulted in permanent damage to the membrane. It can also be seen from Example 3 and FIG. 2 of the Feimer patent that even very low levels of oxygen in the feedstream can have significant and permanent detrimental effects on polymeric membranes.

The invention disclosed in the Feimer patent above (U.S. Pat. No. 5,095,171), is a process of protecting a polymeric membrane in one of three ways. As discussed, the process for protecting the susceptible membranes in the Feimer patent is generally limited to removing oxygen from the process or inhibiting the oxygen utilizing an oxygen scavenger such as a hindered phenol or hindered amine. These methods have the disadvantages of either restricting the feedstream composition, requiring additional separation processes to remove oxygen and associated equipment, or requiring the addition of chemicals that can increase the processing costs and may be incompatible with the product stream specifications.

As can be seen, exposure of a polymer membrane to water or oxygen can result in a severe decrease or nearly complete loss of a membrane's performance. In many cases, the damage to the membrane and the corresponding decline of the membrane performance is both permanent and irreversible. This behavior is unique, unpredictable, and depends on the concentration of contaminants.

As can be seen in FIG. 1, the performance of polymer membranes may be quite sensitive to even very low levels of water in a hydrocarbon-containing feedstream. While the process performance is degraded even at low concentrations of water in the feedstream, an even greater impact is that the water can permanently damage the polymeric membrane. This phenomenon can be seen in FIG. 1, wherein the polymeric membrane flux experienced a steep decline when 76 ppm of water was introduced into the feed without the benefit of the hydrophobic barrier films of the present invention. However, when the majority of the water was removed from the feed (i.e., when reduced to 12 ppm of water), the membrane flux did not return to the flux performance levels prior to contact with the 76 ppm water content feeds. Hence, the polymeric membrane was permanently damaged. It can also be seen in FIG. 1 that even when the feedstream contained only low levels of water (i.e., at 9 ppm and 12 ppm water content in the feed), the polymeric membrane performance steadily and permanently declined.

In one embodiment, the present invention utilizes a hydrophobic barrier film in a membrane assembly to reject a portion of the water contained in a feedstream before contacting a polymeric membrane. Non-limiting examples of hydrophobic films that can be used in the practice of the present invention include films comprised of a compound selected from polytetrafluoroethylene (e.g., Teflon®), polyvinylfluoride, polyvinylidenefluoride, polypropylene, polyethylene, polycarbonate, polysulfone, and silicone. Preferably, the hydrophobic barrier film is comprised of a compound selected from polytetrafluoroethylene, polyvinylfluoride, and polyvinylidenefluoride.

In a process application, the hydrophobic films are oriented on the feedstream side of the polymer membrane to substantially prevent the water from contacting the membrane. As part of this invention, it is desired that the hydrophobic barrier film be substantially impermeable to water. In the context used herein, the term “substantially impermeable to water” means that the concentration by weight of water in the permeate is less than 25% of the concentration by weight of water in the feedstream when utilizing the hydrophobic barrier film in accordance with the present invention. Preferably, the concentration by weight of water in the permeate is less than 10 wt % of the concentration by weight of water in the feedstream, and even more preferably, the concentration by weight of water in the permeate is less than 5 wt % of the concentration by weight of water in the feedstream when utilizing the hydrophobic barrier film in accordance with the present invention. The terms “water”, “concentration of water”, or “concentration by weight of water” as used herein indicate the total of both free and soluble water or the total concentration of both free and soluble water in the identified medium.

This hydrophobic barrier film can be applied directly onto the polymer membrane or a sheet of the hydrophobic barrier film can be co-processed as a separate non-bonded layer onto a polymer membrane where it may be subsequently rolled with the membrane for use in a spiral wound membrane assembly. Alternatively, the sheet of barrier film can be cut into configurations for use in conjunction with a membrane or membranes in either a plate and frame membrane housing assembly or a wafer cassette housing assembly. The hydrophobic barrier film may also be sprayed or vacuum induced onto the polymeric membrane, assembly housing, or support material or may be applied by any other coating procedure known in the art.

FIG. 2 illustrates one embodiment of a membrane assembly of the present invention wherein a suitable housing (1) is utilized to enclose the layered components of the present invention. A suitable housing can consist of virtually any membrane housing configuration known in the art with the required function of the housing being to enclose the layers of the membrane assembly (shown in FIG. 2 as components (5), (6), and (7)); to provide a path for the feedstream (2) to contact the membrane; for a retentate stream (3) and a permeate stream (4) to be removed as separate streams from the housing; and to prevent significant bypassing of feedstream components (2) to the permeate stream (4) without any bypassing of stream components from the feedstream side of the assembly to the permeate side of the assembly without passing through all of the layers of the membrane assembly. In the embodiment shown in FIG. 2, a hydrophobic barrier film (5) is utilized in a membrane assembly to protect a polymeric membrane element (6) cast on a support material (7). It should be noted that the support material (7) may be comprised of any suitable material known in the art utilized for a casting substrate for polymeric membranes. Additionally, the support material is not critical to the present invention and the present invention may be utilized with an unsupported polymeric membrane element or elements.

In a similar manner, the present invention includes the use a barrier film system to protect the polymer membrane from damage from a hydrocarbon feed containing oxygen as a contaminant. The present invention utilizes a vapor barrier film which can be constructed of similar materials as the hydrophobic barrier film including, but not limited to films comprised of a compound selected from polytetrafluoroethylene (e.g., Teflon®), polyvinylfluoride, polyvinylidenefluoride, polypropylene, polyethylene, polycarbonate, polysulfone, and silicone. Preferably, the vapor barrier film is comprised of a compound selected from polytetrafluoroethylene, polyvinylfluoride, and polyvinylidenefluoride.

However, the particular type and grade of vapor barrier film chosen for a particular application depends upon the porosity or “bubble point” rating of the vapor barrier material and the process conditions. The vapor barrier film is chosen with a bubble point rating such that at process conditions the vapor barrier film will substantially impermeable to oxygen. In the context used herein, the term “substantially impermeable to oxygen” means that the concentration by volume of free and dissolved oxygen in the permeate is less than 25% of the concentration by volume of the free and dissolved oxygen in the feedstream when utilizing the vapor barrier film in accordance with the present invention. Preferably, the concentration by volume of free and dissolved oxygen in the permeate is less than 10 wt % of the concentration by volume of the free and dissolved oxygen in the feedstream, and even more preferably, the concentration by volume of free and dissolved oxygen in the permeate is less than 5 wt % of the concentration by volume of free and dissolved oxygen in the feedstream when utilizing the hydrophobic barrier film in accordance with the present invention.

In a similar manner to the hydrophobic barrier films, the vapor barrier film can be applied directly onto the polymer membrane or a sheet of the vapor barrier film can be co-processed as a separate non-bonded layer onto a polymer membrane. Alternatively, the sheet of the vapor barrier film can be cut into configurations for use in conjunction with a membrane or membranes in either a plate and frame membrane housing assembly or a wafer cassette housing assembly. The vapor barrier film may also be sprayed or vacuum induced onto the polymeric membrane, assembly housing, or support material or may be applied by any other coating procedure known in the art.

Similarly, FIG. 2 can be used to illustrate one embodiment of an assembly of the present invention wherein the housing (1), and the feedstream (2), retentate stream (3), and permeate stream (4) have similar functions as prior described. However, in this embodiment, a vapor barrier film (5) is utilized in a membrane assembly to protect a polymeric membrane element (6) cast on a support material (7). As with the hydrophobic barrier film prior, the support material (7) is shown as one embodiment of the present invention and the support material is not critical to nor necessary for implementation of the present invention.

The term “bubble point” or “bubble point properties” as used herein is used to define the pressure below which the vapor barrier film will substantially prevent a vapor from passing through the vapor barrier film (e.g., at below 50 psi operating pressure, a film with a bubble point rating of 50 psi or above will not allow any substantial amount of the vapor components of the feedstream to pass through the film). Also, the term “hydrocarbon” means an organic compound having a predominantly hydrocarbon character. Accordingly, organic compounds containing one or more non-hydrocarbon radicals (e.g., sulfur or oxygen) would be within the scope of this definition. As used herein, the terms “aromatic hydrocarbon” or “aromatic” means a hydrocarbon-based organic compound containing at least one aromatic ring. The rings may be fused, bridged, or a combination of fused and bridged. In a preferred embodiment, the aromatic species separated from the hydrocarbon feed contains one or two aromatic rings. The terms “non-aromatic hydrocarbon” or “non-aromatic” or “saturate” means a hydrocarbon-based organic compound having no aromatic cores. Also as used herein, the term “selectivity” means the ratio of the desired component(s) in the permeate to the non-desired component(s) in the permeate divided by the ratio of the desired component(s) in the feedstream to the non-desired component(s) in the feedstream. Also, the term “flux” or “normalized flux” is defined the mass rate of flow of the permeate across a membrane, normally expressed in units of Kg/m²-day, Kg/m²-hr, Kg-μm/m²-day, or Kg-μm/m²-hr.

In a preferred embodiment, the hydrophobic barrier films and the vapor barrier films may be utilized in conjunction where there is a need to protect the polymer membrane from both water and oxygen contamination. In this case, manufacturing of the hydrophobic and vapor barrier films onto the polymer membrane can be performed in a manner similar to when only one of the film layers is required. One of these films may be coated onto the polymer membrane followed by a coating of the other film directly upon the first film. Alternatively, a sheet of each the hydrophobic barrier film and the vapor barrier film can be layered onto a polymer membrane which may be subsequently rolled with the membrane for use in a spiral wound membrane assembly. Alternatively, the sheets of hydrophobic and vapor barrier films can be cut into configurations for use in conjunction with a membrane or membranes in either a plate and frame membrane housing assembly or a wafer cassette housing assembly. The hydrophobic and vapor barrier films may also be sprayed or vacuum induced onto the polymeric membrane, assembly housing, or support material or may be applied by any other coating procedure known in the art.

FIG. 3 illustrates one embodiment of an assembly of the present invention wherein both a separate hydrophobic barrier film (15) and a separate a vapor barrier film (16) is utilized in a membrane assembly to protect a polymeric membrane element (17) cast on a support material (18). As shown in this FIG. 3, the housing (11), and the feedstream (12), retentate stream (13), and permeate stream (14) have similar functions and properties as in the embodiment described in FIG. 2 (shown in FIG. 2 as components (1), (2), (3), and (4), respectively).

In another preferred embodiment, process conditions may be such that a single film composition and properties can be selected such that the single film can provide both the water and oxygen barrier characteristics required for the application in accordance with the present invention. Here, a single sheet of film material is selected such that it possesses the hydrophobic properties required for the application as well as the bubble point properties necessary to substantially prevent the free & dissolved oxygen from passing through the barrier film and contacting the membrane under the process conditions.

FIG. 2 can also be used to illustrate one embodiment of an assembly of the present invention wherein a combination hydrophobic barrier/vapor barrier film (5) is utilized in a membrane assembly to protect a polymeric membrane element (6) cast on a support material (7). Again here the housing (1), and the feedstream (2), retentate stream (3), and permeate stream (4) have similar functions and properties as described prior for FIG. 2.

In a preferred embodiment, the hydrophobic barrier film and/or vapor barrier film of the present invention is utilized in conjunction with a polymer membrane element comprised of a dianhydride, a diamine, a crosslinking agent a difunctional dihydroxy polymer selected from:

a) dihydroxy end-functionalized condensation homopolymers, copolymers, terpolymers and higher order compositions of structurally different monomers, including alcohol-terminated end-functionalized esters and dihydroxy end-functionalized multimonomer polyesters; and mixtures thereof;

wherein the polyalkyladipate structures range from C₁ to C₁₈; and

b) dihydroxy end-functionalized urethane homopolymers, copolymers, terpolymers, and higher order compositions of structurally different monomers. These polymeric membrane compositions are susceptible to damage from excessive water and/or oxygen contaminants in hydrocarbon feedstreams.

In yet another embodiment, the hydrophobic barrier and/or the vapor barrier may be in the form of a polymeric membrane layer which is incorporated onto a layer of polymer membrane (herein referred to as the “active polymer membrane layer”) which is to be protected from excessive contact with water and/or oxygen. In this embodiment, the barrier membrane layer and the active polymer membrane layer are chemically crosslinked thereby forming an integral multi-layer membrane element. Details of preferred embodiments and applications of chemically-crosslinked integral multi-layered membranes are more fully described in the co-pending application in a concurrently filed, co-pending U.S. Patent Application Ser. No. 60/836,424 filed on Aug. 8, 2006 and its corresponding U.S. Utility patent application Ser. No. ______ entitled “Integrally-Layered Polymeric Membranes and Method of Use” which is herein incorporated by reference.

In one embodiment, the hydrophobic barrier membrane layer and/or the vapor barrier membrane layer is comprised of a dianhydride, a diamine, a crosslinking agent a difunctional dihydroxy polymer selected from:

a) dihydroxy end-functionalized ethylene propylene copolymers with an ethylene content from about 25 wt % to about 80 wt %;

b) dihydroxy end-functionalized ethylene propylene diene terpolymers with an ethylene content from about 25 wt % to about 80 wt %;

c) dihydroxy end-functionalized acrylate homopolymers, copolymers and terpolymers; dihydroxy end-functionalized methacrylate homopolymers, copolymers and terpolymers; and mixtures thereof,

wherein the mixtures of acrylate and methacrylate monomers range from C₁ to C₁₈;

d) dihydroxy end-functionalized perfluoroelastomers;

e) dihydroxy end-functionalized carbonate homopolymers, copolymers, terpolymers, and higher order compositions of structurally different monomers;

f) dihydroxy end-functionalized ethylene alpha-olefin copolymers;

dihydroxy end-functionalized propylene alpha-olefin copolymers; and dihydroxy end-functionalized ethylene propylene alpha-olefin terpolymers;

wherein the alpha-olefins are linear or branched and range from C₃ to C₁₈;

g) dihydroxy end-functionalized styrene homopolymers, copolymers, terpolymers, and higher order compositions of structurally different monomers; and

h) dihydroxy end-functionalized silicone homopolymers, copolymers, terpolymers, and higher order compositions of structurally different monomers.

This hydrophobic barrier membrane layer and/or the vapor barrier membrane layer are utilized in conjunction with an active polymer membrane layer comprised of a dianhydride, a diamine, a crosslinking agent a difunctional dihydroxy polymer selected from:

a) dihydroxy end-functionalized condensation homopolymers, copolymers, terpolymers and higher order compositions of structurally different monomers, including alcohol-terminated end-functionalized esters and dihydroxy end-functionalized multimonomer polyesters; and mixtures thereof;

wherein the polyalkyladipate structures range from C₁ to C₁₈; and

b) dihydroxy end-functionalized urethane homopolymers, copolymers, terpolymers, and higher order compositions of structurally different monomers.

The hydrophobic barrier membrane layer and/or the vapor barrier membrane layer protects the active polymer membrane layer from excessive water and/or oxygen contaminants in hydrocarbon feedstreams which can damage the active polymer membrane layer and/or detrimentally impact the separation performance of the active polymer membrane layer.

The term “active polymer membrane layer” as used herein designates a layer of the polymer membrane element may be susceptible to physical damage or performance degradation by water and/or oxygen at operating conditions and plays an active role in the selective separation of feedstream components via permeation of the feedstream components. The term “active” is not meant to suggest that the hydrophobic barrier and/or vapor barrier layers and/or films may not be used in part to provide selective separation of the feedstream components, but is a term merely selected as to differentiate the susceptible polymer membrane layer(s) from the protective barrier layer(s).

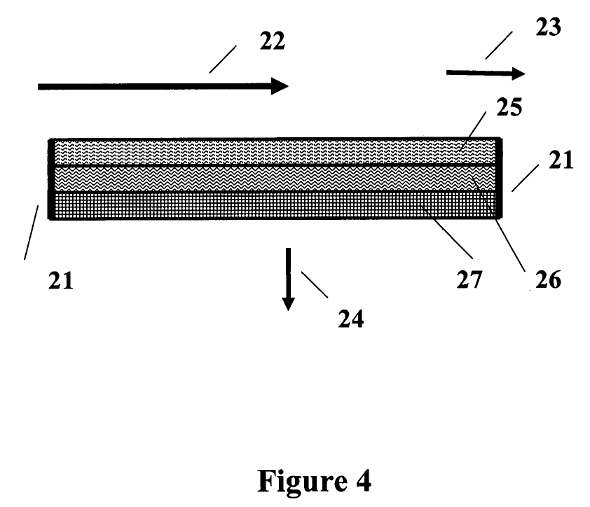

FIG. 4 illustrates one embodiment of a membrane assembly of the present invention wherein a hydrophobic barrier membrane layer (25) is utilized to protect an active polymer membrane layer (26) which may be susceptible to damage by contact with water. However, in this embodiment, the hydrophobic barrier membrane layer and the active polymer membrane layer are chemically crosslinked thereby forming an integral multi-layer membrane element which is utilized in a suitable housing (21) for the separation of a hydrocarbon stream. As shown in this FIG. 4, the housing (21), and the feedstream (22), retentate stream (23), and permeate stream (24) have similar functions and properties as in the embodiment described in FIG. 2 (shown in FIG. 2 as components (1), (2), (3), and (4), respectively). In FIG. 4, the active polymer membrane layer (26) is shown cast on a support material (27). As in the prior embodiments illustrated herein, the support material (27) may be comprised of any suitable material known in the art utilized for a casting substrate for polymeric membranes. Additionally, the support material is not critical to the present invention and the present invention may be utilized with an unsupported polymeric membrane element or elements.

Another benefit of the present invention is that an aromatics enriched permeate product with a decreased water concentration may be obtained in a single separations step. The permeate product may then be utilized in subsequent processes where water is detrimental to the process or associated processing equipment, or in final products such as motor gasoline blending wherein the product must meet mandated specification limits on overall water content.

In a preferred embodiment, a hydrophobic barrier film/layer, a vapor barrier film/layer, both barrier films/layers, or a film/layer with both hydrophobic and vapor barrier properties is utilized in an assembly comprised of multiple polymer membranes elements and/or membrane comprised of multiple integrated layers. The membrane assembly can be comprised of membrane elements and/or membranes with multiple layers wherein the elements and/or layers are comprised of the same polymer composition, the same polymer concentration, different polymer compositions, or different polymer concentrations. The membrane assembly may also be comprised of membrane elements or membrane element layers combinations of the same or differing membrane element thicknesses or densities.

The membrane assembly comprised of the hydrophobic and vapor barrier films and/or layers of the present invention can be employed in any housing configuration such as, but not limited to, flat plate elements, wafer elements, spiral-wound elements, porous monoliths, porous tubes, or hollow fiber elements. More preferably the membrane housing configuration is selected from flat plate elements, wafer elements, spiral-wound elements, and porous monoliths. Even more preferably the membrane housing configuration is selected from flat plate elements, wafer elements, and spiral-wound elements.

The membrane hydrophobic and vapor barrier films/layers described herein are useful in processes for separating a selected component or species from a liquid feed, a vapor/liquid feed, or a condensing vapor feeds. The films are utilized in both perstractive and pervaporative separation processes.

In a preferred embodiment, the barrier films/layers of the present invention will operate at a temperature less than the temperature at which the film performance would deteriorate or the film would be physically damaged or decomposed. For hydrocarbon separations, the process temperature would preferably range from about 75° F. to about 500° F. (24 to 260° C.).

In a preferred embodiment, the hydrophobic and/or vapor barrier films/layers are utilized in processes for the selective separation of aromatics from a hydrocarbon feedstream containing aromatics and non-aromatics.

In a preferred embodiment, the hydrophobic and/or vapor barrier films/layers are utilized in processes for selective separation of sulfur and nitrogen heteroatoms from a hydrocarbon stream containing sulfur heteroatoms and nitrogen heteroatoms.

In still another embodiment, the barrier films/layers of the present invention are utilized in processes wherein the hydrocarbon feedstream is a naphtha with a boiling range of about 80 to about 450° F. (27 to 232° C.), and contains aromatic and non-aromatic hydrocarbons. In a preferred embodiment, the aromatic hydrocarbons are separated from the naphtha feedstream. As used herein, the term naphtha includes thermally cracked naphtha, catalytically cracked naphtha, and straight-run naphtha. Naphtha obtained from fluid catalytic cracking processes (“FCC”) are particularly preferred due to their high aromatic content.

Although the present invention has been described in terms of specific embodiments, it is not so limited. Suitable alterations and modifications for operation under specific conditions will be apparent to those skilled in the art. It is therefore intended that the following claims be interpreted as covering all such alterations and modifications as fall within the true spirit and scope of the invention.

What is claimed is:

1. A membrane assembly for separating aromatics from a hydrocarbon feedstream containing aromatics and non-aromatics comprised of:
a) at least one polymer membrane element, and
b) a hydrophobic barrier film;
wherein the polymer element and the hydrophobic barrier film are enclosed in a housing; the hydrophobic barrier film is oriented in the housing on the feedstream side of the polymer membrane element; and the hydrophobic barrier film is substantially impermeable to water.

2. The membrane assembly of claim 1, wherein the hydrophobic barrier film is comprised of a compound selected from polytetrafluoroethylene, polyvinylfluoride, polyvinylidenefluoride, polypropylene, polyethylene, polycarbonate, polysulfone, and silicone.

3. The membrane assembly of claim 2, wherein at least one polymer membrane element is comprised of a dianhydride, a diamine, a crosslinking agent, and a difunctional dihydroxy polymer selected from:
a) dihydroxy end-functionalized condensation homopolymers, copolymers, terpolymers and higher order compositions of structurally different monomers, including alcohol-terminated end-functionalized esters and dihydroxy end-functionalized multimonomer polyesters; and mixtures thereof;
wherein the polyalkyladipate structures range from C₁ to C₁₈; and
b) dihydroxy end-functionalized urethane homopolymers, copolymers, terpolymers, and higher order compositions of structurally different monomers.

4. The membrane assembly of claim 2, wherein the hydrophobic barrier film is directly coated onto the polymer membrane element.

5. The membrane assembly of claim 2, wherein the hydrophobic barrier film is a separate sheet in the membrane assembly.

6. A membrane assembly for separating aromatics from a hydrocarbon feedstream containing aromatics and non-aromatics comprised of:
a) at least one polymer membrane element, and
b) a vapor barrier film;
wherein the polymer element and the vapor barrier film are enclosed in a housing; the vapor barrier film is oriented in the housing on the feedstream side of the polymer membrane element; and the vapor barrier film is substantially impermeable to oxygen.

7. The membrane assembly of claim 6, wherein the vapor barrier film is comprised of a compound selected from polytetrafluoroethylene, polyvinylfluoride, polyvinylidenefluoride, polypropylene, polyethylene, polycarbonate, polysulfone, and silicone.

8. The membrane assembly of claim 7, wherein at least one polymer membrane element is comprised of a dianhydride, a diamine, a crosslinking agent a difunctional dihydroxy polymer selected from:
a) dihydroxy end-functionalized condensation homopolymers, copolymers, terpolymers and higher order compositions of structurally different monomers, including alcohol-terminated end-functionalized esters and dihydroxy end-functionalized multimonomer polyesters; and mixtures thereof;
wherein the polyalkyladipate structures range from C₁ to C₁₈; and
b) dihydroxy end-functionalized urethane homopolymers, copolymers, terpolymers, and higher order compositions of structurally different monomers.

9. The membrane assembly of claim 7, wherein the vapor film is directly coated onto the polymer membrane element.

10. The membrane assembly of claim 7, wherein the vapor film is a separate sheet in the membrane assembly.

11. The membrane assembly of claim 8, comprised of a hydrophobic barrier film oriented in the housing on the feedstream side of the polymer membrane element; and the hydrophobic barrier film is substantially impermeable to water.

12. The membrane assembly of claim 8, wherein the vapor barrier film is also hydrophobic and substantially impermeable to water, and is comprised of a compound selected from polytetrafluoroethylene, polyvinylfluoride, polyvinylidenefluoride, polypropylene, polyethylene, polycarbonate, polysulfone, and silicone.

13. A process for separating a hydrocarbon feedstream containing aromatic components and non-aromatic components, comprising:
a) contacting the hydrocarbon feedstream with one side of a membrane assembly; and
b) removing an aromatic enriched permeate stream from the opposite side of the membrane assembly;
wherein the membrane assembly is comprised of a housing containing at least one polymer membrane element and at least one hydrophobic barrier film; the hydrophobic barrier film is oriented in the housing on the feedstream side of the polymer membrane element; and the hydrophobic barrier film is substantially impermeable to water.

14. The process of claim 13, wherein the concentration by weight of water in the aromatic enriched permeate stream is less than 10% of the concentration by weight of water in the hydrocarbon feedstream.

15. The process of claim 13, wherein the hydrophobic barrier film is comprised of a compound selected from polytetrafluoroethylene, polyvinylfluoride, polyvinylidenefluoride, polypropylene, polyethylene, polycarbonate, polysulfone, and silicone.

16. The process of claim 13, wherein at least one polymer membrane element is comprised of a dianhydride, a diamine, a crosslinking agent, and a difunctional dihydroxy polymer selected from:
a) dihydroxy end-functionalized condensation homopolymers, copolymers, terpolymers and higher order compositions of structurally different monomers, including alcohol-terminated end-functionalized esters and dihydroxy end-functionalized multimonomer polyesters; and mixtures thereof;
wherein the polyalkyladipate structures range from C₁ to C₁₈; and
b) dihydroxy end-functionalized urethane homopolymers, copolymers, terpolymers, and higher order compositions of structurally different monomers.

17. The process of claim 16, wherein the hydrophobic barrier film is comprised of a dianhydride, a diamine, a crosslinking agent, and a difunctional dihydroxy polymer selected from:
a) dihydroxy end-functionalized ethylene propylene copolymers with an ethylene content from about 25 wt % to about 80 wt %;
b) dihydroxy end-functionalized ethylene propylene diene terpolymers with an ethylene content from about 25 wt % to about 80 wt %;
c) dihydroxy end-functionalized acrylate homopolymers, copolymers and terpolymers; dihydroxy end-functionalized methacrylate homopolymers, copolymers and terpolymers; and mixtures thereof,
wherein the mixtures of acrylate and methacrylate monomers range from C₁ to C₁₈;
d) dihydroxy end-functionalized perfluoroelastomers;
e) dihydroxy end-functionalized carbonate homopolymers, copolymers, terpolymers, and higher order compositions of structurally different monomers;
f) dihydroxy end-functionalized ethylene alpha-olefin copolymers; dihydroxy end-functionalized propylene alpha-olefin copolymers; and dihydroxy end-functionalized ethylene propylene alpha-olefin terpolymers;
wherein the alpha-olefins are linear or branched and range from C₃ to C₁₈;
g) dihydroxy end-functionalized styrene homopolymers, copolymers, terpolymers, and higher order compositions of structurally different monomers; and
h) dihydroxy end-functionalized silicone homopolymers, copolymers, terpolymers, and higher order compositions of structurally different monomers.

18. The process of claim 17, wherein the hydrocarbon feedstream is a naphtha with a boiling range of about 80 to about 450° F. (27 to 232° C.).

19. The process of claim 18, wherein the concentration by weight of water in the aromatic enriched permeate stream is less than 10% of the concentration by weight of water in the hydrocarbon feedstream.

20. The process of claim 19, wherein the hydrophobic barrier film is substantially impermeable to oxygen.
